(19) United States
(12) Patent Application Publication
(10) Pub. No.: US 2013/0226867 A1
(43) Pub. Date: Aug. 29, 2013

(54) APPARATUS AND METHOD FOR CONVERTING REPLICATION-BASED FILE INTO PARITY-BASED FILE IN ASYMMETRIC CLUSTERING FILE SYSTEM

(71) Applicants: Sang-Min Lee, Daejeon (KR); Young-Kyun Kim, Daejeon (KR); Wan Choi, Daejeon (KR)

(72) Inventors: Sang-Min Lee, Daejeon (KR); Young-Kyun Kim, Daejeon (KR); Wan Choi, Daejeon (KR)

(73) Assignee: Electronics and Telecommunications Research Institute, Daejeon-city (KR)

(21) Appl. No.: 13/608,691

(22) Filed: Sep. 10, 2012

(30) Foreign Application Priority Data
Feb. 24, 2012 (KR) 10-2012-0018939

(51) Int. Cl. G06F 17/00

(52) U.S. Cl. 707/610; 707/E17.007

(57) ABSTRACT

Disclosed herein are an apparatus and method for converting a replication-based file into a parity-based file in an asymmetric clustering file system. The apparatus includes a reception unit, a control unit, a parity computation unit, and a chunk conversion unit. The reception unit receives a parity-based conversion request, information about the size of a stripe, and a list of new chunks from a metadata server. The control unit divides a replication chunk, selected from among a plurality of replication chunks corresponding to an original chunk of the replication-based file, into a plurality of data segments. The parity computation unit generates at least one parity segment by performing a parity operation on the plurality of data segments. The chunk conversion unit selects one of different data segments from the original chunk or one of the plurality of replication chunks, the different data segments having locations different from one another.

### CROSS REFERENCE TO RELATED APPLICATION

This application claims the benefit of Korean Patent Application No. 10-2012-0018939, filed on Feb. 24, 2012, which is hereby incorporated by reference in its entirety into this application.

### BACKGROUND OF THE INVENTION

1. Technical Field

The present invention relates generally to an apparatus and method for converting a replication-based file into a parity-based file in an asymmetric clustering file system. In particular, the present invention relates to an apparatus and method for converting a replication-based file into a parity-based file in an asymmetric clustering file system, which, in a replication-based structure in which a file is divided into chunks of determined size, the chunks are stored in respective data storages of different data servers, and one or more replication chunks for each original chunk are stored in the respective data storages of the different data servers, enable a target file to be converted into a parity-based structure file and then stored automatically based on a data life cycle or in response to a request from a user.

2. Description of the Related Art

Generally, an asymmetric clustering file system includes a metadata server for managing the metadata of files, a plurality of data servers for managing the data of the files, and a plurality of clients for storing or searching the files.

The metadata server, the plurality of data servers, and the plurality of clients are connected and communicate with each other over a local network. The plurality of data servers can be provided in the form of a single large-scale storage space using a virtualization technology. The storage space can be freely managed by adding or deleting a data server or the volume of a data server. Systems for managing a plurality of data servers as described above have used a mirroring technology for storing replication-based files, which maintain the replication of data in order to provide for a failure rate which is proportional to the number of data servers.

However, the above-described mirroring technology for storing replication-based files has low storage efficiency because data is redundantly stored. Furthermore, in a service for sharing files over the web, a file is frequently accessed during a specific period after the upload of the file, and then the frequency of access is decreased over time. Therefore, the management of such files having low access frequencies using a double or triple replication scheme causes a waste of storage volume.

In order to overcome the problems of the mirroring technology, a conventional technology is provided that sets the size of a stripe in advance when a file is stored using a triple replication scheme, distributes and stores first replication chunks in different data servers, and stores second replication chunks in the same data server. Thereafter, when the file is converted into a parity-based file, the second replication chunks are converted into parity chunks by performing a parity operation on the second replication chunks, and the first replication chunks distributed and stored in the different data servers are read and converted into parities.

### SUMMARY OF THE INVENTION

Accordingly, the present invention has been made keeping in mind the above problems occurring in the prior art, and an object of the present invention is to provide a technology for converting a replication-based file into a parity-based file, which when a replication-based file is converted into a parity-based file in an asymmetric clustering file system, is capable of directly converting a single chunk into a single stripe, thereby minimizing overhead which results from the calculation of double parities and also minimizing the efficiency which affects data input/output performance during conversion into a parity-based file.

In order to accomplish the above object, the present invention provides a method for converting a replication-based file into a parity-based file in an asymmetric clustering file system, the method including selecting a replication chunk for performing parity-based file conversion from among a plurality of replication chunks, the plurality of replication chunks corresponding to an original chunk of a replication-based file; dividing the selected replication chunk into a plurality of data segments; generating at least one parity segment by performing a parity operation on the plurality of data segments; selecting each of different data segments from each of the original chunk and the plurality of replication chunks, the different data segments having locations different from one another; replicating the parity segment; and replicating remaining data segments except for the each of the different data segments selected from the each of the original chunk and the plurality of replication chunks.

The selecting the replication chunk may include determining a size of a stripe for the original chunk; and allocating new chunks, which will be used to replicate the parity segment and the remaining data segments except for the each of different data segments from the each of the original chunk and the plurality of replication chunks.

The number of the new chunks may be “the size of the stripe+a number of the parity segments−(a number of the replication chunks+1).”

The dividing the selected replication chunk into a plurality of data segments may include determining a size of each of the data segments of the stripe by dividing the selected replication chunk by the determined size of the stripe; and determining a start offset of each of the plurality of data segments based on the determined size of each of the data segments.

The selecting each of different data segments from each of the original chunk and the plurality of replication chunks may include converting the original chunk into a data segment, a size of which corresponds to the determined size of each of the data segments ranging from the start offset of a first data segment of the plurality of data segments.

The selecting each of different data segments from each of the original chunk and the plurality of replication chunks may further include converting the replication chunks except for the selected replication chunk into data segments, a size of which corresponds to the determined size of each of the data segments ranging from the start offset of a data segment other than the first data segment and a last data segment of the plurality of data segments.

The selecting each of different data segments from each of the original chunk and the plurality of replication chunks may further include converting the selected replication chunk into a data segment, a size of which corresponds to the determined size of each of the data segments ranging from the start offset of the last data segment of the plurality of data segments.

In order to accomplish the above object, the present invention provides an apparatus for converting a replication-based file into a parity-based file in an asymmetric clustering file system, the apparatus including a reception unit for receiving a parity-based conversion request, information about a size of a stripe, and a list of new chunks from a metadata server; a control unit for dividing a replication chunk, selected to perform a parity-based file conversion from among a plurality of replication chunks corresponding to an original chunk of the replication-based file, into a plurality of data segments; a parity computation unit for generating at least of parity segment by performing a parity operation on the plurality of data segments; and a chunk conversion unit for selecting each of different data segments from each of the original chunk and the plurality of replication chunks, the different data segments having locations different from one another; wherein the control unit replicates the parity segments generated by the parity computation unit and remaining data segments except for the each of different data segments from the each of the original chunk and the plurality of replication chunks, and transmits the replicated parity segment and remaining data segments to data servers on which the new chunks are allocated.

The control unit may divide the selected replication chunk into the plurality of data segments based on the size of the stripe.

The number of the new chunks may be “the size of the stripe+a number of the parity segments−(a number of the replication chunks+1).”

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram illustrating the structure of an asymmetric clustering file system to which the present invention is applied;

FIG. 2 is a diagram illustrating a method of distributing and storing a replication-based file in the asymmetric clustering file system to which the present invention is applied;

FIG. 3 is a diagram illustrating a parity-based restoration information structure which is configured by a metadata server in order to perform distributed processing on a parity-based file in the asymmetric clustering file system to which the present invention is applied;

FIG. 4 is a diagram illustrating a method by which a metadata server requests that data servers which store replication chunks convert a replication-based file into a parity-based file in the asymmetric clustering file system to which the present invention is applied;

FIG. 5 is a block diagram illustrating the internal structure of the data server in the asymmetric clustering file system to which the present invention is applied;

FIG. 6 is a diagram illustrating a method of generating parity segments based on the replication chunk;

FIGS. 7 and 8 are flowcharts illustrating a method for converting a replication-based file into a parity-based file in the asymmetric clustering file system to which the present invention is applied; and

FIG. 9 is a diagram illustrating a structure in which a replication-based file is converted into a parity-based file and then the resulting file is stored in the asymmetric clustering file system to which the present invention is applied.

### DESCRIPTION OF THE PREFERRED EMBODIMENTS

Reference now should be made to the drawings, throughout which the same reference numerals are used to designate the same or similar components.

An apparatus and method for converting a replication-based file into a parity-based file in an asymmetric clustering file system according to embodiments of the present invention will be described below with reference to the accompanying drawings.

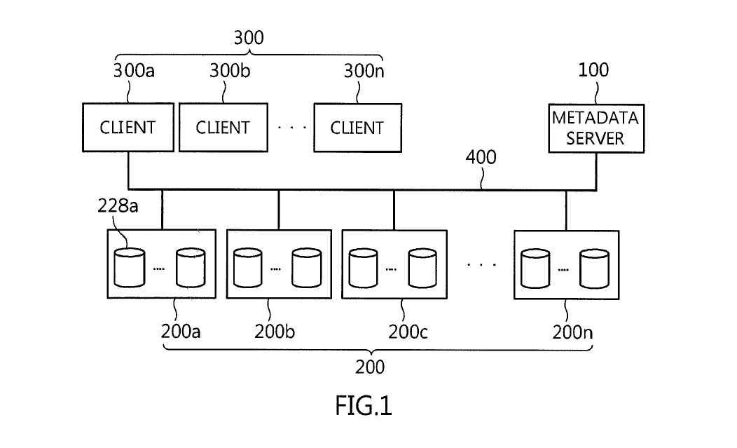

FIG. 1 is a diagram illustrating the structure of an asymmetric clustering file system to which the present invention is applied.

A metadata server 100 manages the metadata of files. The metadata server 100 may use a database or a local file system as data storage for storing the metadata of files. A plurality of data servers 200a to 200n (200) store and manage the data of files. Each of the data servers is equipped with one or more disk storage devices 228a. The size of the storage space of the data server is determined based on the number of disk storage devices which are mounted on the data server. The plurality of data servers 200a to 200n (200) may use a local file system as data storage for storing the data of files. Clients 300a, 300b, . . . and 300n (300) access the files. Each of files stored by the clients 300a, 300b, . . . and 300n is divided into predetermined units, called chunks, and the chunks obtained through the division are stored in advance in the data servers 200a to 200n which are different from each other. Here, the metadata server 100, the plurality of data servers 200a to 200n (200), and the clients 300a, 300b, . . . and 300n (300) are connected and communicate with each other over a network 400 such as an Ethernet.

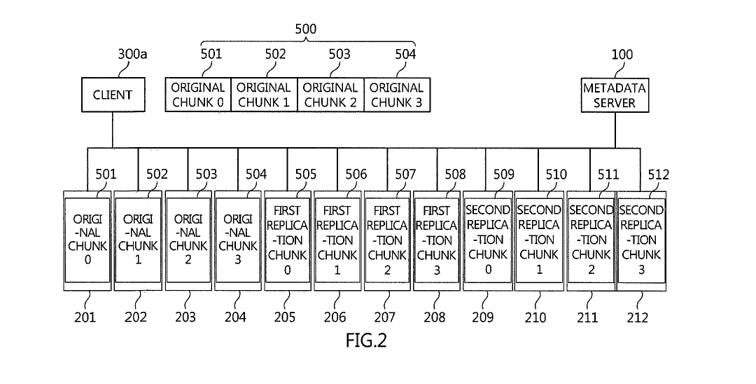

FIG. 2 is a diagram illustrating a method of distributing and storing a replication-based file in the asymmetric clustering file system to which the present invention is applied.

A client 300a divides file A 500 into predetermined units (for example, chunks), and stores the units obtained through the division. Here, the size of each unit obtained through the division is a value which is set in advance or which is defined by a user who configures a file system, for example, a value obtained by dividing the size of the file A 500 by the number of data servers used for storage. In this case, one or more replication chunks are stored for each of a predetermined number of original chunks 501 to 504 into which the client 300a divides the file A 500. The metadata server 100 determines the data servers 201 to 212 for storing the original chunks 501 to 504 and the replication chunks 505 to 512 by taking into consideration of the rate of the use of the storage space of each of the data servers 201 to 212. The metadata server 100 notifies the client 300a of the results of the determination.

FIG. 2 illustrates a case where a file system is set using a triple replication scheme. This drawing illustrates a structure in which double replication chunks are stored for each original chunk. In FIG. 2, original chunk 0 501 is stored in a data server 201, and original chunk 1 502 is stored in a data server 202, original chunk 2 503 is stored in a data server 203, and original chunk 3 504 is stored in a data server 204. Furthermore, first replication chunk 0 505 is stored in a data server 205, first replication chunk 1 506 is stored in a data server 206, first replication chunk 2 507 is stored in a data server 207, and first replication chunk 3 508 is stored in a data server 208. Moreover, second replication chunk 0 509 is stored in a data server 209, second replication chunk 1 510 is stored in a data server 210, second replication chunk 2 511 is stored in a data server 211, and second replication chunk 3 512 is stored in a data server 212. Here, each of the original chunks and the double replication chunks thereof should be stored in different data servers, respectively. However, different chucks may be stored in the same data server. For example, the original chunk 1 502, the first replication chunk 3 508 and the second replication chunk 0 509 can be stored in the same data server.

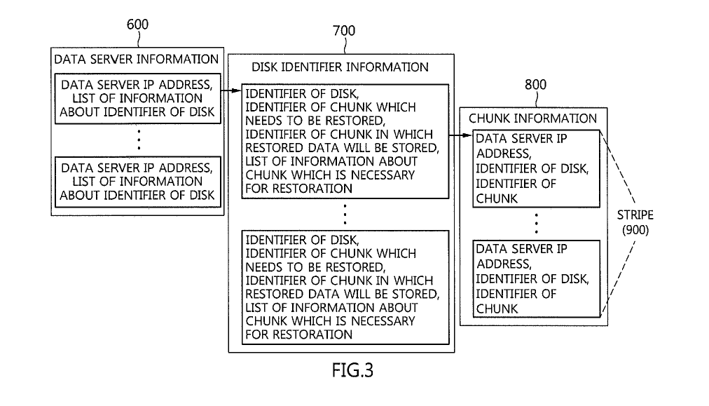

FIG. 3 is a diagram illustrating a parity-based restoration information structure which is configured by a metadata server in order to perform distributed processing on a parity-based file in the asymmetric clustering file system to which the present invention is applied.

The metadata server 100 detects a data server having trouble from a data server group. When the data server having trouble is detected, the metadata server 100 examines the asymmetric clustering file system and configures a restoration information structure. The metadata server 100 transmits the configured restoration information structure to a data server of a data server group which is different from the data server group including the data server having trouble.

The structure of restoration information includes data server information 600, including, for each data server, a data server Internet Protocol (IP) address and a disk identifier information list. The disk identifier information list includes disk identifier information 700, including, for each disk identifier, the identifier of a chunk which needs to be restored, the identifier of a chunk in which restored data will be stored, and a list of information about a chunk which is necessary for restoration. The list of information about a chunk which is necessary for restoration includes chunk information 800, including a data server IP address to which a chunk is stored, the identifier of a disk, and the identifier of a chunk.

Here, the identifier of a chunk which needs to be restored is information about the identification of a chunk which is selected from among the chunks stored in the data server having trouble. The identifier of a chunk in which restored data will be stored is information about the identification of a chunk in which an erroneous chunk will be restored and then newly stored. The list of information about a chunk which is necessary for restoration is a list of information about a parity chunk and data which are necessary to restore the erroneous chunk. A single parity chunk and data chunks which are used to calculate a parity are called a single stripe 900. Here, the size of the stripe 900 may be set in advance, or may be determined in advance by a user who configures a file system.

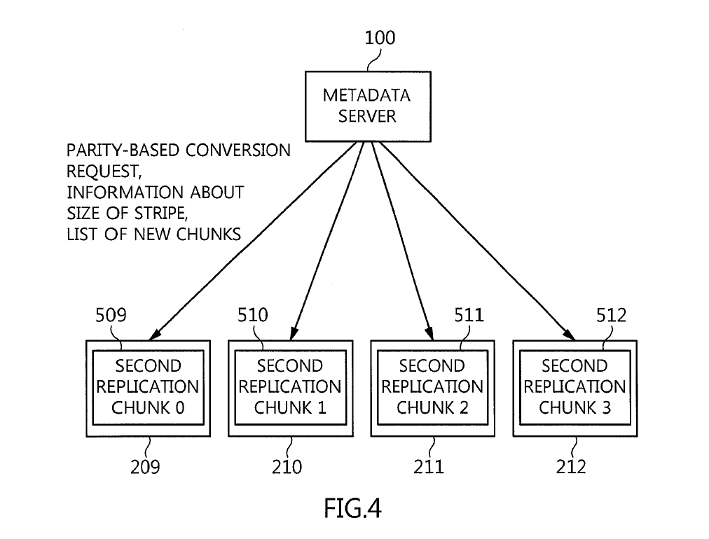

FIG. 4 is a diagram illustrating a method by which the metadata server 100 requests that data servers storing replication chunks convert a replication-based file into a parity-based file in the asymmetric clustering file system to which the present invention is applied.

Referring to FIG. 4, the metadata server 100 selects a desired file which will be converted into a parity-based file, and allocates new chunks, the number of which corresponds to “the size of a stripe+the number of parity segments−(the number of replication chunks+1),” to different data servers for each original chunk of the corresponding file. Here, the reason why “the number of replication chunks+1” is subtracted from “the sum of the size of a stripe+the number of parity segments” is that the original chunks and the replication chunks are used as data chunks which are included in the stripe. Here, the new chunks, which are allocated for the different original chunks, may be allocated to the same data server.

The metadata server 100 requests the data servers 209, 210, 211 and 212, which store the respective replication chunks of the corresponding file which will be converted from a replication-based file into a parity-based file, to perform parity-based file conversion. Here, if one or more replication chunks are present for each original chunk as in a triple replication scheme, the parity-based file conversion can be requested by selecting a random replication chunk from among the replication chunks or by selecting the last replication chunk. In FIG. 4, for example, in order to convert a file including four chunks into a parity-based file for which the size of a single stripe is 4 in a triple replication scheme, the parity-based file conversion is requested by selecting the second replication chunks 509, 510, 511 and 512, which are the last replication chunks. When the last replication chunks are selected as described above, there is an advantage in that the original chunks and other replication chunks can be used for data input/output processing while the selected replication chunks are converted into a stripe. In FIG. 4, the metadata server 100 requests that the data server 209 for storing the second replication chunk 0 509, the data server 210 for storing the second replication chunk 1 510, the data server 211 for storing the second replication chunk 2 511 and the data server 212 for storing the second replication chunk 3 512 perform parity-based file conversion. Further, the metadata server 100 transmits information about the size of the stripe and a list of new chunks. Here, it is preferable that the method of requesting parity-based conversion by the metadata server 100 be performed using an asynchronous method rather than a synchronous method. The synchronous method is performed in such a way as to wait until parity-based conversion is terminated in a specific data server. The asynchronous method is performed in such a way as to first request parity-based conversion and then receive a conversion completion response from each of the data servers 509 to 512.

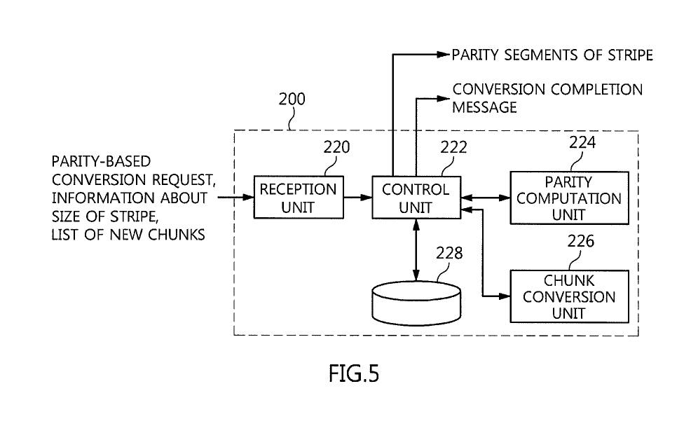

FIG. 5 is a block diagram illustrating the internal configuration of a data server in the asymmetric clustering file system to which the present invention is applied.

The data server 200 includes a reception unit 220, a control unit 222, a parity computation unit 224, a chunk conversion unit 226, and a storage unit 228. Here, it may be understood that the data server 200 refers to each of the data servers 200a to 200n shown in FIG. 1.

The reception unit 220 receives a parity-based conversion request, information about the size of a stripe, and a list of new chunks from the metadata server 100. Here, the received list of new chunks is a list of the disk identifier information 700 about the new chunks which are allocated to different data servers for each original chunk of a desired file which is desired to be converted into a parity-based file by the metadata server 100. Instead of a description of the disk identifier information 700, the description given above in conjunction with FIG. 3 is used.

The control unit 222 divides a replication chunk, which is selected from among a plurality of replication chunks to be used to perform parity-based file conversion, into a plurality of data segments for each original chunk of a replication-based file. That is, the control unit 222 divides the replication chunk, which is selected to be used to perform the parity-based file conversion by the metadata server 100, into a plurality of unit data segments based on the information about the size of a stripe. Here, the control unit 222 calculates the size of the unit data segment of a stripe by dividing the replication chunk by the size of a stripe based on the information about the size of a stripe which was received from the metadata server. For example, when the size of the replication chunk is 64 Mbyte and the predetermined size of a stripe is 4, the replication chunk is logically divided into unit data segments, the size of which is 16 Mbyte, by the control unit 222. Furthermore, the control unit 222 determines the start offset of each of the segments of the replication chunk based on the calculated size of the unit data segment. As described above by way of example, when the size of the replication chunk is 64 Mbyte and the size of a predetermined stripe is 4, the start offset of segment 0 is 0 Mbyte, the start offset of segment 1 is 16 Mbyte, the start offset of segment 2 is 32 Mbyte, and the start offset of a segment 3 is 48 Mbyte. Meanwhile, the control unit 222 replicates the parity segments of the stripe generated by the parity computation unit 224 and then transmits the parity segments to data servers to which the new chunks have been allocated. Further, the control unit 222 replicates remaining data segments except for each of different data segments which selected from the each of the original chunk and the plurality of replication chunks, and then transmits the replicated remaining data segments to data servers to which the new chunks have been allocated. Once the conversion from a replication-based file into a parity-based file has been terminated, the control unit 222 transmits a conversion completion message to the metadata server 100.

The parity computation unit 224 generates the parity segments of the stripe by performing a parity operation on the plurality of data segments obtained through division performed on the replication chunk by the control unit 222. Here, a parity operation algorithm which is used by the parity computation unit 224 to generates the parity segments of the stripe is an algorithm which is implemented by a user.

The chunk conversion unit 226 selects a different data segment from the original chunk or the plurality of replication chunks. Here, each of the different data segments has a location different from one another. Further, the chunk conversion unit 226 may convert the replication chunk, which is selected from among the plurality of replication chunks to be used to perform parity-based file conversion, into a data segment which corresponds to the location of any one of the plurality of data segments obtained through division performed on the replication chunk. Here, the chunk conversion unit 226 may convert the selected replication chunk into a data segment corresponding to the size of the unit data segment ranging from the start offset of the last one of the plurality of data segments obtained through division performed by the control unit 222. That is, as described above by way of example, when the size of the replication chunk is 64 Mbyte and the predetermined size of a stripe is 4, the file of the selected replication chunk may be converted into a file, the size of which corresponds to the size of a unit data segment ranging from 48 Mbyte, which is the start offset of the last data segment of the plurality of data segments obtained through division performed by the control unit 222. Further, the chunk conversion unit 226 may convert the original chunk into a data segment ranging from a start offset of a first data segment of the plurality of data segments, and one of replication chunks except for the selected replication chunk into a data segment ranging from a start offset of a data segment other than the first data segment and a last data segment of the plurality of data segments.

The storage unit 228 stores the data of a file on a chunk basis. Here, it may be understood that the storage unit 228 corresponds to the disk storage device 228a in FIG. 1.

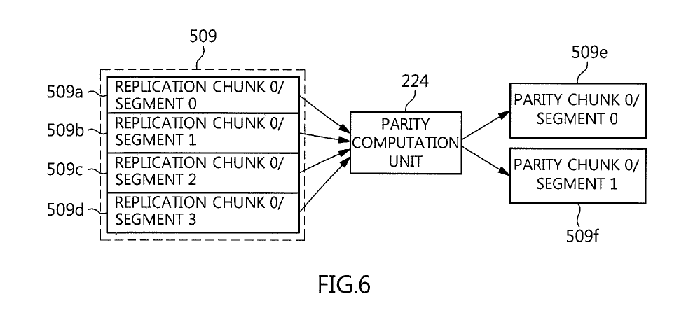

FIG. 6 is a diagram illustrating a method of generating parity segments based on a replication chunk.

FIG. 6 illustrates an example in which two parity segments are generated based on the second replication chunk 0 509 for convenience of description. However, a replication chunk corresponding to the target of parity segment generation and the number of generated parity segments are not limited thereto. Referring to FIG. 6, when the size of a replication chunk is 64 Mbyte and the predetermined size of a stripe is 4, the second replication chunk 0 509 is first divided by the size of a stripe, thereby being divided into a plurality of data segments 509a, 509b, 509c, and 509d of the stripe. Here, the second replication chunk 0 509 is logically divided into data segment 0 509a, data segment 1 509b, data segment 2 509c, and data segment 3 509d each of which has a size of 16 Mbyte. The parity computation unit 224 performs a parity operation on the plurality of data segments 509a, 509b, 509c and 509d which are obtained through the division, thereby generating parity segment 0 509e and parity segment 1 509f. Such parity segment generation processing is performed on the second replication chunk 1 510, the second replication chunk 2 511, and the second replication chunk 3 512 in the same manner.

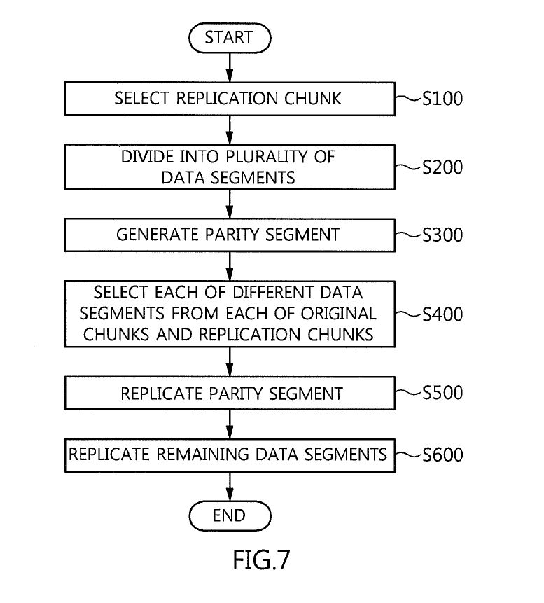

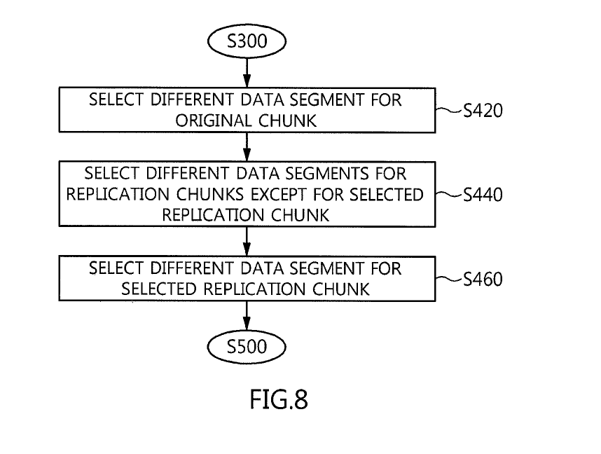

FIGS. 7 and 8 are flowcharts illustrating a method for converting a replication-based file into a parity-based file in the asymmetric clustering file system to which the present invention is applied.

Referring to FIG. 7, in the method for converting a replication-based file into a parity-based file in the asymmetric clustering file system according to the present invention, the metadata server first selects a desired replication-based file which will be converted into a parity-based file, and selects at least one replication chunk, on which parity-based file conversion will be performed, from among a plurality of replication chunks for each of the original chunks of the selected replication-based file at step S100. Here, the metadata server determines the size of a stripe for the original chunk, and allocates new chunks, the number of which corresponds to “the size of a stripe+the number of parity segments−(the number of replication chunks+1)”, to different data servers for the original chunk. The new chunks allocated by the metadata server are used to replicate the data segments except for parity segments generated based on the original chunk and data segments obtained through conversion performed on the original chunk and the plurality of replication chunks, which will be described later. The metadata server transmits a request for the parity-based file conversion to the data server which stores the replication chunk selected to perform the parity-based file conversion. Here, the metadata server also transmits both information about the determined size of the stripe and a list of new chunks to the data server.

When the data server, which stores the replication chunk selected to be used to perform the parity-based file conversion, receives the request for the parity-based file conversion from the metadata server, the data server divides the replication chunk selected by the metadata server into a plurality of data segments at step S200. Here, the data server determines the size of each of the data segments included in the stripe by dividing the selected replication chunk by the predetermined size of the stripe, and determines the start offset of each of the plurality of data segments obtained through division performed based on the determined size of each of the data segments.

Thereafter, the data server generates parity segments by performing a parity operation on the plurality of data segments obtained through division performed on the selected replication chunk at step S300. That is, the data server generates one or more parity segments by performing a parity operation in such a way as to read data corresponding to the size of a data segment determined based on the start offset of each of the plurality data segments obtained through division performed on the selected replication chunk.

Thereafter, once the generation of the parity segments has been terminated at step S300, data servers select each of different data segments from each of an original chunk of the replication-based file and the plurality of replication chunks corresponding to the original chunk at step S400. Here, the different data segments having locations different from one another. Further, the data servers convert each of the original chunk and the plurality of replication chunks of the original chunk into a data segment of a stripe, the location of which is different from the locations of the remaining segments of the plurality of data segments obtained through the division.

Thereafter, the data server replicates the generated parity segments and stores the replicated parity segments in the different data servers which are allocated to store the parity segments and in which the new chunks will be stored at step S500. Here, the data server searches the list of new chunks, received from the metadata server, for the corresponding data servers, and replicates the one or more generated parity segments into the found data servers.

Further, the data server replicates remaining data segments except for the each of the different data segments obtained through selection performed on the original chunk and the plurality of replication chunks at step S600. That is, the data server replicates the remaining data segments except for the different data segments obtained through selection performed on the original chunk and the replication chunks at step S400, and stores the remaining data segments in respective data servers to which the new chunks have been allocated.

Once the conversion from a single chunk to a single stripe has been terminated according to steps S100 to S600, the data server can transmit a message notifying that the parity-based conversion has been completed to the metadata server.

FIG. 8 is a flowchart illustrating step S400 of selecting each of different data segments from each of the original chunk and the plurality of replication chunks in further detail in the method for converting a replication-based file into a parity-based file in the asymmetric clustering file system according to the present invention shown in FIG. 7.

Referring to FIG. 8, at step S400 of selecting each of different data segments from each of the original chunk and the plurality of replication chunks, a data server, which stores the original chunk, first selects a different data segment from the original chunk at step S420. The size of the different data segment which selected by the data server at step S420 corresponds to the predetermined size of a data segment ranging from the start offset of the first data segment of the plurality of data segments obtained through division. Here, the data server, which stores the original chunk, converts the original chunk into a data segment of a stripe. That is, when the generation of the parity segments is terminated at S300, the data server which stores an original chunk converts the original chunk file into a file which has the predetermined size of a data segment ranging from the start offset of the first data segment, that is, 0 Mbyte.

Thereafter, a data server, which stores the replication chunk except for the replication chunk selected by the metadata server at step S100, selects a different data segment from the remaining replication chunk at step S440. The size of the different data segment which selected by the data server at step S440 corresponds to the predetermined size of a data segment ranging from the start offset of the data segment, except for the first and last data segments of the plurality of data segments obtained through division. Here, the data server which stores the remaining replication chunk converts the remaining replication chunk into a data segment of a stripe, the size of which corresponds to the predetermined size of a data segment ranging from the start offset of the data segment, except for the first and last data segments of the plurality of data segments obtained through division. That is, in a structure in which one or more replication chunks are stored as in a triple replication scheme, in order to use the remaining replication chunks, except for a replication chunk which is currently being used for parity-based conversion, as the data segments of a stripe, the data servers which store the replication chunks except for the replication chunk selected by the metadata server convert the remaining replication chunk files into files each having the predetermined size of a data segment ranging from the start offset of one of the data segments except for the first and last data segments. For example, when the size of a chunk is 64 Mbyte and the predetermined size of a stripe is 4, the replication chunks expect for the replication chunk selected by the metadata server is converted into files each having the predetermined size of a data segment ranging from a start offset 16 Mbyte.

Finally, the data server, which stores the replication chunk selected by the metadata, selects a different data segment from the selected replication chunk at step S460. The size of the different data segment which selected by the data server at step S460 corresponds to the predetermined size of a data segment ranging from the start offset of the last data segment of the plurality of data segments obtained through division. Here, the data server which stores the selected replication chunk converts the selected replication chunk into a data segment of a stripe which corresponds to the size of the predetermined data segment ranging from the start offset of the last data segment of the plurality of data segments obtained through division. That is, the data server, which stores the replication chunk selected by the metadata, converts the selected replication chunk into a file having the predetermined size of the data segment ranging from the start offset of the last data segment. For example, when the size of the chunk is 64 Mbyte and the predetermined size of a stripe is 4 in a triple replication scheme, the replication chunk selected by the metadata server is converted into a file having the predetermined size of the data segment ranging from a start offset 48 Mbyte. Meanwhile, in the present invention, step S460 of selecting the different data segment from the replication chunk selected by the metadata server and converting the replication chunk into the data segment of a stripe may be performed after step S600 of FIG. 7.

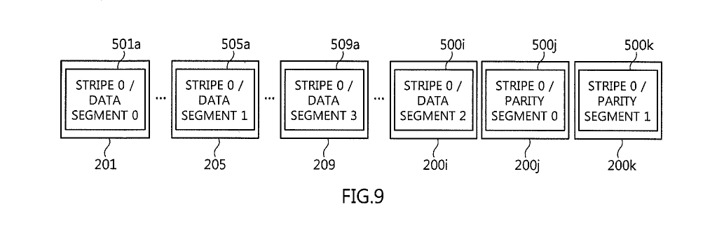

FIG. 9 is a diagram illustrating a structure in which a replication-based file is converted into a parity-based file and then the resulting file is stored in the asymmetric clustering file system according to the present invention.

As the method for converting a replication-based file into a parity-based file is performed according to the present invention, the replication-based file which has been stored in the structure shown in FIG. 2 is converted into four stripes each of which the size is 4. FIG. 9 illustrates a structure in which the original chunk 0 shown in FIG. 2 is converted into stripe 0 and then stored. Referring to FIG. 9, in the data server 201 which stores the original chunk 0 501 in FIG. 2, the original chunk 0 501 is converted into a file which has the size of a data segment of a stripe and stored as data segment 0 501a of the stripe 0. Further, in the data server 205 which stores the first replication chunk 0 505 in FIG. 2, the first replication chunk 0 505 is converted into a file which has the size of the data segment of the stripe and stored as data segment 1 505a of the stripe 0. Further, in the data server 209 which stores the second replication chunk 0 509 in FIG. 2, the second replication chunk 0 509 is converted into a file which has the size of the data segment of the stripe and stored as data segment 3 509a of the stripe 0. The remaining data segment 2 500i of the stripe 0 is replicated as a new chunk which is allocated to a data server 200i. Meanwhile, parity segment 0 500j and parity segment 1 500k of the stripe 0 are replicated and stored as new chunks which are respectively allocated to a data server 200j and a data server 200k. The remaining original chunks 502, 503 and 504 in FIG. 2 are converted into stripes using the same method as the original chunk 0 501 and then stored.

In accordance with the present invention, when a replication-based file is converted into a parity-based file in an asymmetric clustering file system, a single chunk is directly converted into a single stripe and double parities are calculated in real time, so that there are the advantages of increasing the availability of a system and minimizing the influence that the overhead occurring during conversion into the parity-based file has on data input/output performance.

Although the preferred embodiments of the present invention have been disclosed for illustrative purposes, those skilled in the art will appreciate that various modifications, additions, and substitutions are possible, without departing from the scope and spirit of the invention as disclosed in the accompanying claims.

What is claimed is:

1. A method for converting a replication-based file into a parity-based file in an asymmetric clustering file system, the method comprising:
selecting a replication chunk for performing parity-based file conversion from among a plurality of replication chunks, the plurality of replication chunks corresponding to an original chunk of a replication-based file;
dividing the selected replication chunk into a plurality of data segments;
generating at least one parity segment by performing a parity operation on the plurality of data segments;
selecting each of different data segments from each of the original chunk and the plurality of replication chunks, the different data segments having locations different from one another;
replicating the parity segment; and
replicating remaining data segments except for the each of the different data segments selected from the each of the original chunk and the plurality of replication chunks.

2. The method as set forth in claim 1, wherein the selecting the replication chunk comprises:
determining a size of a stripe for the original chunk; and
allocating new chunks, which will be used to replicate the parity segment and the remaining data segments except for the each of different data segments from the each of the original chunk and the plurality of replication chunks.

3. The method as set forth in claim 2, wherein a number of the new chunks is “the size of the stripe+a number of the parity segments−(a number of the replication chunks+1).”

4. The method as set forth in claim 2, wherein the dividing the selected replication chunk into a plurality of data segments comprises:
determining a size of each of the data segments of the stripe by dividing the selected replication chunk by the determined size of the stripe; and
determining a start offset of each of the plurality of data segments based on the determined size of each of the data segments.

5. The method as set forth in claim 4, wherein the selecting each of different data segments from each of the original chunk and the plurality of replication chunks comprises:
converting the original chunk into a data segment, a size of which corresponds to the determined size of each of the data segments ranging from the start offset of a first data segment of the plurality of data segments.

6. The method as set forth in claim 5, wherein the selecting each of different data segments from each of the original chunk and the plurality of replication chunks further comprises:
converting the replication chunks except for the selected replication chunk into data segments, a size of which corresponds to the determined size of each of the data segments ranging from the start offset of a data segment other than the first data segment and a last data segment of the plurality of data segments.

7. The method as set forth in claim 6, wherein the selecting each of different data segments from each of the original chunk and the plurality of replication chunks further comprises:
converting the selected replication chunk into a data segment, a size of which corresponds to the determined size of each of the data segments ranging from the start offset of the last data segment of the plurality of data segments.

8. An apparatus for converting a replication-based file into a parity-based file in an asymmetric clustering file system, the apparatus comprising:
a reception unit for receiving a parity-based conversion request, information about a size of a stripe, and a list of new chunks from a metadata server;
a control unit for dividing a replication chunk, selected to perform a parity-based file conversion from among a plurality of replication chunks corresponding to an original chunk of the replication-based file, into a plurality of data segments;
a parity computation unit for generating at least one parity segment by performing a parity operation on the plurality of data segments; and
a chunk conversion unit for selecting one of different data segments from the original chunk or one of the plurality of replication chunks, the different data segments having locations different from one another;
wherein the control unit replicates the parity segment generated by the parity computation unit and remaining data segments except for each of the different data segments selected from the each of the original chunk and the plurality of replication chunks, and transmits the replicated parity segment and remaining data segments to data servers on which the new chunks are allocated.

9. The apparatus as set forth in claim 8, wherein the control unit divides the selected replication chunk into the plurality of data segments based on the size of the stripe.

10. The apparatus as set forth in claim 9, wherein a number of the new chunks is “the size of the stripe+a number of the parity segments−(a number of the replication chunks+1).”
